(19) United States
(12) Patent Application Publication
(10) Pub. No.: US 2022/0011091 A1
(43) Pub. Date: Jan. 13, 2022

(54) COMPUTATIONAL SHEAR BY PHASE STEPPED SPECKLE HOLOGRAPHY

(71) Applicant: BAE Systems Information and Electronic Systems Integration Inc., Nashua, NH (US)

(72) Inventors: Andrew N. Acker, Honolulu, HI (US); Jacob D. Garan, Honolulu, HI (US)

(73) Assignee: BAE Systems Information and Electronic Systems Integration Inc., Nashua, NH (US)

(21) Appl. No.: 16/925,420

(22) Filed: Jul. 10, 2020

(51) Int. Cl. G01B 9/02; G01B 11/16

(52) U.S. Cl. CPC G01B 9/02098; G01B 2290/45; G01B 11/162

(57) ABSTRACT

A method and apparatus for performing shearography where the shear length and direction can be set in image processing, thus allowing all shear sizes to be computed and tested from a single data set, which can be collected in a single pass over a test surface or test object. The present process assures that a single data set can be processed with optimal shear length for multiple target types, thus reducing or eliminating the chance of missing a target detection while additionally enhancing target shape analysis by allowing the calculation of target response versus shear length and shear direction.

### TECHNICAL FIELD

The present disclosure relates generally to shearography. More particularly, in one example the present disclosure relates to shearography methods for generating shearograms with multiple shears. Specifically, in another example, the present disclosure relates to shearography methods to generate multiple shearograms with several different shears from a single data set.

### BACKGROUND

Shearography, or speckled pattern shearing interferometry as it is sometimes called, is a non-destructive measuring and testing method utilizing coherent light or sound waves to provide information about the quality of different materials. Generally speaking, shearography uses comparative images, known as shear images or shearograms, of a surface or object both with and without a load applied to the target surface or object to create an interference pattern known as a specklegram. The interference pattern is created by using a reference image of the test object and shearing that image to create a double image. Superimposing those two images upon each other provides a shear image (shearogram) representing the surface of the test object in a first state, which is typically an unloaded state. Then a load is applied to the surface or test object to cause a minor deformation therein. From this a second shear image is generated and is compared with the first shear image to reveal inconsistencies between the two, which in turn may represent a flaw in the surface or the presence of an unknown or unseen object within or below the surface.

One common use of shearography is to detect buried objects in a substrate wherein the surface of the substrate is the subject surface for shearography and the comparison between shear images may reveal the presence of an object buried in that substrate. The buried objects produce a time dependent distortion in the surface of the substrate which can be accomplished by inducing the buried objects to vibrate by, for example, ensonificsation by an external sound source. When used in such an application, standard shearography methods generate shearograms with a single fixed shear. The optimal shear length for an object buried within a substrate is often related to the diameter of the object type. Specifically, buried objects tend to show maximum response when detected at a shear length that is approximately one-half of the object's diameter. Thus, when searching for multiple objects of varying sizes, multiple shear lengths are needed to ensure detection of all objects within the substrate, as well as detection of those objects at or near their optimum shear. In current shearography systems, if a shearogram with a different shear is desired, the physical hardware of the system must be adjusted and a second or subsequent data set must be collected. When shearography is used for remote detection of buried objects, the need for multiple shear lengths requires multiple passes over the substrate surface with varying adjustments made to the hardware for each pass. This introduces limits to the capability of current shearography systems as each desired shear length first requires a physical adjustment to the system hardware and then requires an additional pass over the target surface. In some cases, multiple passes over the target surface are not feasible as these systems are commonly employed in combat zones and multiple passes over the target surface may pose a threat to the operator of the shearography system. Alternatively, time constraints or cost constraints may also limit the number of passes a shearography system can make over a target surface. Thus, if searching for buried objects consisting of different sized objects with a current shearography system, many objects may not be detected at their optimum shear and some objects may not be detected at all.

### SUMMARY

The present disclosure addresses these and other issues by providing a method and apparatus for performing shearography where the shear length and direction can be set in image processing, thus allowing all shear sizes to be computed and tested from a single data set, which can be collected in a single pass over a test surface or test object. The present process assures that a single data set can be processed with optimal shear length for multiple target types, thus reducing or eliminating the chance of missing a target detection while additionally enhancing target shape analysis by allowing the calculation of target response versus shear length and shear direction.

In one aspect, an exemplary embodiment of the present disclosure may provide a method of performing shearography comprising: reflecting a target illumination beam off of a target surface via a transmitter optical component of a shearography system; directing a reference beam from the transmitter optical component to a receiving optical component of the shearography system; receiving a reflected beam from the target surface with the receiving optical component; communicating a data set relating to the reflected beam relative to the reference beam from the receiving optical component to a processor; and processing the data set to generate at least two shear image sets having different shear lengths for each image set.

In another aspect, an exemplary embodiment of the present disclosure may provide a system for detecting objects beneath a target surface, the system comprising: a transmitter optical component operable to generate and reflect a target illumination beam off of the target surface; a receiver optical component operable to receive a reflected beam from the target surface illuminated by the target illumination beam; and a processor in operative communication with the receiver optical component operable to generate at least two shear image sets having different shear lengths for each of the at least two shear image sets from a single data set collected in a single pass of the system over the target surface.

In yet another aspect, an exemplary embodiment of the present disclosure may provide a computer program product including one or more non-transitory machine-readable storage mediums encoding instructions that when executed by one or more processors cause a process to be carried out for generating multiple shear image sets with each image set of the multiple shear image sets having a different shear length, the process comprising: receiving a reflected beam from a target surface that is illuminated by a target illumination beam; collecting a single data set from the received beam relative to a reference beam; and generating at least two shear image sets from the single data set with each image set from the at least two image sets having different shear lengths.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a schematic view of a shearography system according to one aspect of the present disclosure.

FIG. 2 is a schematic view of the shearography system of FIG. 1 in a second configuration, according to one aspect of the present disclosure.

FIG. 3 is a simplified schematic view of the shearography system of FIGS. 1 and 2, according to one aspect of the present disclosure.

FIG. 4 is an operational view of a vehicle performing shearography utilizing the shearography system according to one aspect of the present disclosure.

FIG. 5 is a flow chart of an exemplary method according to one aspect of the present disclosure.

Similar numbers refer to similar parts throughout the drawings.

### DETAILED DESCRIPTION

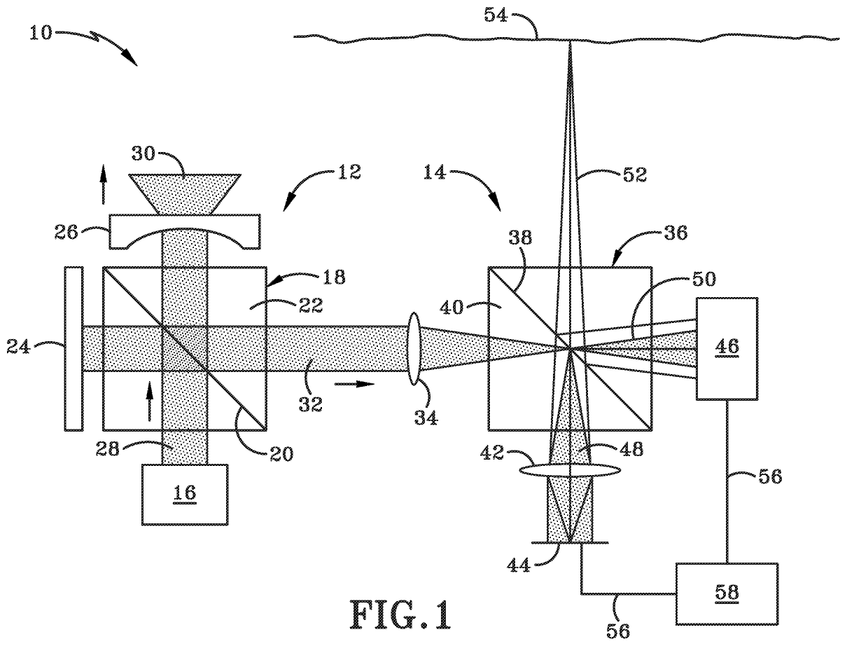

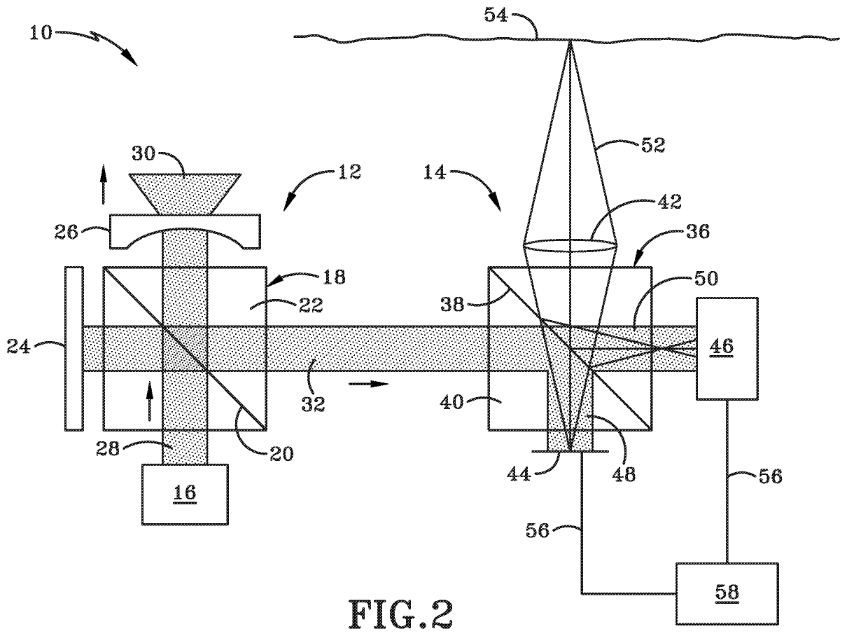

With reference to FIGS. 1 and 2, a phase stepping speckle holography system is shown and generally indicated at reference 10. The phase stepping speckle system 10 may be further referred to herein as system 10 or simply as system 10. System 10 may include two main components, namely a transmitter optical component hereinafter referred to as transmitter optics 12 and a receiver optical component hereinafter referred to as receiver optics 14.

Transmitter optics 12 may include a light input 16, a first beamsplitter or first splitter 18 having a first splitting surface 20 immersed in a first medium 22. Transmitter optics 12 may further include a mirror 24 and a diverger lens 26. Transmitter optics 12, as discussed further herein, may be operable to direct a light beam 28 into the first splitter 18 where at least a portion of the light beam 28 may be directed to the mirror 24 with at least a second portion of the light beam 28 directed through the diverger lens 26 and out towards a target surface 54 in the form of a target illumination beam 30. The other portion of light beam 28 may reflect off of mirror 24 back through first splitter 18 and into the receiver optics 14 as a reference beam 32. The operation of transmitter optics will be further discussed below.

Receiver optics may include a lens 34, a second splitter 36 having a second splitting surface 38 immersed in a second medium 40, an objective lens 42, an image plane 44, and a beam dump 46. Reference beam 32 may enter into the receiver optics through lens 34 and into second splitter 36 where it may be divided into a first arm 48 and a second arm 50, which may travel out of the second beamsplitter 36 to the image plane 44 and the beam dump 46, respectively. Receiver optics may also receive a reflection of the target illumination beam 30 indicated and shown in the figures as reflected beam 52. Reflected beam 52 may reflect off of the target surface 54 and into the second splitter 36 where it may be recombined with the reference beam 32 with at least a portion of the reflected beam 52 being directed to the image plane 44 while at least another portion of reflected beam 52 may be directed to the beam dump 46.

Receiver optics 14, or more particularly, image plane 44 and/or beam dump 46 may further include one or more outputs 56 connecting to a processor 58 as discussed further herein.

Light input 16 may be a beam generator such as a laser beam generator operable to produce a monochromatic and/or coherent laser light that can be used to measure surface displacements on the target surface 54. According to another aspect, light input 16 may be any device operable to produce a light beam suitable for use in shearography to measure surface displacement and/or surface irregularities as discussed further herein. According to a few non-limiting examples, light input 16 may be a laser transmitter, the aforementioned laser beam generator, or may be an input source from a remote beam generator or beam director assembly utilizing additional optical components such as mirrors, collimators, divergers or the like to generate and/or direct light beam 28 into and through transmitter optics 12 as discussed further herein.

Both first splitter 18 and second splitter 36 may be substantially similar in that they may be beam splitting devices that are commonly used in shearography applications as well as in other beam splitting applications. According to one example, first and second splitters 18, 36 may be cube beam splitters having first splitting surface 20 and second splitting surface 38, respectively, immersed in a medium such as first medium 22 and/or second medium 40, which may be optical glass or another suitable medium as dictated by the desired implementation. Splitting surfaces 20, 38 may be optical components operable to split a beam with at least a portion of the beam being directed 90 degrees from the input direction while at least another portion of the beam may travel straight through splitting surfaces 20, 38. Splitting surfaces 20, 38 may consist of an optical coating or a separate splitting structure embedded in or otherwise immersed in first and/or second medium 22, 40. The main recognized difference between first splitter 18 and second splitter 36 may be their position within system 10 such that first splitter 18 may be disposed within or as part of the transmitter optics 12 while second splitter may be disposed within and/or as part of the receiver optics 14. Second splitter 18 may be oriented within receiver optics 14 to serve as a beam recombining optic, as discussed below. The orientation and operation of first and second splitters 18, 36 will be discussed further herein.

According to one aspect, in place of first splitter 18, second splitter 36, or both first and second splitters 18 and 36, system 10 may be configured to employ a window with an anti-reflective coating to divide the light beam 28 into the target illumination beam 30 and reference beam 32. This implementation may reduce the difference in signal between test and reference wavefronts at the image plane 44.

Mirror 24 may be a standard pellicle or optic mirror, which may reflect the portion of light beam 28 back towards first splitter 18, as discussed further herein. According to one aspect, mirror 24 may be a Piezo mirror or a tilting mirror, which may move or otherwise be movable on a two or three-axis basis as dictated by the desired implementation.

Diverger lens 26 may be a single primary diverger lens in that it may be primarily responsible for all or substantially all of the divergence of light beam 28 as it travels therethrough and spreads to become target illumination beam 30. According to one aspect, diverger lens 26 may be a standard optical component configured and operable to produce the target illumination beam 30 from light beam 28 according to the desired implementation of system 10. According to another aspect, diverger lens 26 may be a spherical optical component configured and operable to produce the target illumination beam 30 from light beam 28.

Lens 34 may similarly be a standard optical component or optical lens and may be formed of any suitable optical quality material including, but not limited to, optical glass. Lens 34 may have beam shaping attributes such that lens 34 may be used to shape reference beam 32 as it passes therethrough while entering into receiver optics 14 as discussed further herein. According to another aspect, lens 34 may be omitted from system 10, such as is shown in FIG. 2 and discussed further below.

Objective lens 42 may similarly be a standard optical component or optical lenses and may be formed of any suitable optical quality material including, but not limited to, optical glass. Objective lens 42 may have beam shaping attributes such that objective lens 42 may be used to shape reflected beam 52 as it passes therethrough before encountering image plane 44 (FIG. 1) or before entering into receiver optics 14 (FIG. 2), as discussed further herein.

Image plane 44 may be an optical detector of any type suitable for the desired implementation and dependent upon the beam properties being measured. According to one aspect, image plane 44 may be a focal plane array (FPA). In applications utilizing an FPA, image plane 44 may have a series of light sensing pixels arranged in a square or rectangular pattern and operable to detect and/or measure beam properties such as wave length, phase, and the like, of both reference beam 32 and/or reflected beam 52. According to another aspect, image plane 44 may be any other optical detector, such as a camera or the like, as dictated by the desired implementation. Image plane 44 may further include one or more filters operable to filter out specific wave lengths or other specific properties of reference beam 32 and/or reflected beam 52.

Beam dump 46 may be any suitable device designed to absorb the energy of reference beam 32 and/or reflected beam 52. According to one aspect, beam dump 46 may instead be a second detector, such as a second image plane, camera, FPA, or the like, and may be utilized to measure different qualities of reference beam 32 and/or reflected beam 52. Where beam dump 46 is a second detector, it may alternatively be used to measure like qualities of reference beam 32 and/or reflected beam 52 as a backup or redundant measurement, as dictated by the desired implementation.

Depending on the specific application of system 10, target surface 54 may be a ground surface, i.e., the surface forming the ground beneath or otherwise opposite from system 10. According to another aspect, target may be the surface of a target object such as a machine or structure being tested using shearography techniques such as those described below. For purposes of consistency and clarity in this disclosure only, target surface 54 will hereinafter be referred to as a ground surface comprising a substrate having one or more objects buried therein, as discussed further below. This exemplary use of system 10 as discussed below is understood to be a representative example of use, and not a limiting use thereof.

Processor 58 may be a computer, a processor, a logic, a logic controller, a series of logics, or the like which may include or be in further communication with one or more non-transitory storage mediums and may be operable to both in code and/or carry out a set of encoded instructions contained thereon. Processor 58 may control system 10, including transmitter optics 12 and/or receiver optics 14, to dictate or otherwise oversee the operations thereof as discussed further herein. Processor 58 may be in further communications with other systems or processor such as other computers or systems carried alongside or along with system 10 as discussed further below. According to one non-limiting example, where system 10 is carried by a vehicle 62 as discussed below, processor 58 may be in further communication with other systems on the vehicle 62 such as onboard navigational computers and the like.

With reference to FIG. 2, a second configuration of system 10 is shown and may differ from the configuration shown in FIG. 1 only in the placement of the objective lens 42 and the omission of lens 34. Otherwise, like numbered components may be substantially similar or identical to their counterparts as shown in FIG. 1. With regards to the placement of objective lens 42 as shown in FIG. 2, the objective lens may be placed ahead of the second splitter 36 such that the reflected beam 52 encounters the objective lens as it enters the receiver optics 14 rather than between the second splitter 36 and the image plane 44, as is depicted in FIG. 1.

Components of system 10 are illustrated throughout the figures in both specific and generalized configurations and positions; however, it will be understood that each individual component may be placed and/or located at any position within system 10, or within or on vehicle 62. Accordingly, it will be understood that the particulars of the configuration and/or installation of system 10, including as a standalone system or in/on vehicle 62, (or other structure) with which system 10 is carried or otherwise installed, may dictate the positioning and/or placement of individual components. According to another aspect, the components of system 10 may be moved or moveable between multiple positions depending upon the desired use for a specific implementation or as dictated by the particulars of the vehicle 62 being used, as discussed further herein. The specific configuration and placement of system 10 and the components thereof, is therefore considered to be the architecture of system 10 and may be specifically and carefully planned to meet the needs of any particular system 10. The architecture thereof may also be changed or upgraded as needed.

Further, according to one aspect, the processes and systems described herein may be adapted for use with legacy systems, i.e., existing architecture, without a need to change or upgrade such systems. According to another aspect, certain components may be legacy components while other components may be retrofitted for compatibility with legacy components to complete or otherwise enhance system 10, as discussed further herein.

Having thus described the general configurations and components of system 10, the operation and methods of use thereof will now be discussed.

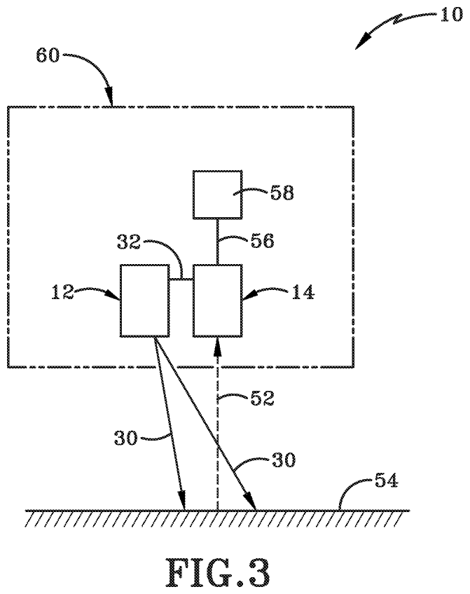

While the operation of system 10 will be described in further detail below, at its most basic, as illustrated in FIG. 3, system 10 may operate such that transmitter optics 12 may generate and direct the target illumination beam 30 towards the target surface 54 which may then reflect energy from the target illumination beam 30 back to the receiver optics 14 as reflected beam 52. The receiver optics 14 may detect the reflected beam 52 and may communicate specific data about the reflected beam 52 relative to a reference beam 32 generated from transmitter optics 12 to receiver optics 14 through the one or more outputs 56 to processor 58 for further processing as discussed below.

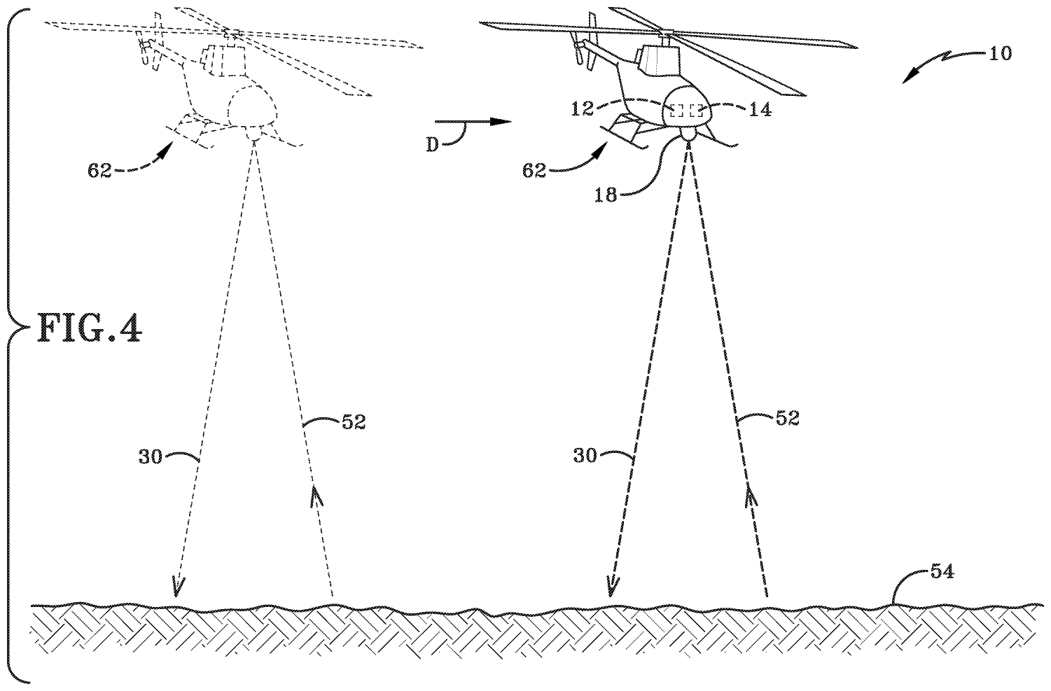

With reference to FIG. 4, an operational example is shown wherein system 10 is carried by a vehicle 62. While depicted herein as a helicopter, it will be understood that vehicle 62 may be a vehicle of any type that is capable of carrying system 10 while operating the same for use in imaging processes such as shearography. According to one aspect, vehicle 62 may be a helicopter or another type of aircraft either manned or unmanned, including other fixed wing and/or rotary aircraft. According to another aspect, vehicle 62 may be a sea based, or land based vehicle, or system 10 may be a manned portable device, i.e., a device that may be carried by one or more persons while being operated.

As depicted in FIG. 4, vehicle 62 carrying system 10 may move in a direction of travel D across the target surface 54, as indicated by the arrow at the top of FIG. 4. As vehicle 62 travels over target surface 54 and performs shearography, multiple measurements may be taken of target surface 54 owing to the movement of vehicle 62. Specifically, vehicle 62 may have a first position, illustrated in dashed lines, where it may take a first set of images and collect a first data set relating to the target surface 54 at that location. Then, vehicle 62 may move to a second position, illustrated in solid lines, where a second set of images and second data set relating to the target surface 54 at that location may be recorded.

By way of this example, as vehicle 62 moves over the target surface 54, system 10 may generate and record several shear images and data sets relating to one or more specific locations on target surface. When used for detection of objects within or under the target surface 54, each position of vehicle 62 may be viewed as a separate set of images and data, and may be analyzed according to the processes herein for the presence of such buried objects. Each individual image set and data set may be generated and recorded utilizing a single fixed shear, as discussed below. In other words, as vehicle 62 moves between positions, no adjustment to the position or configuration of system 10 components is necessary, and multiple passes over the same location are likewise unnecessary, as discussed further herein.

A shear or shearing of an image, at its most basic, is the process of changing the wave front signal to induce interference patterns into the signal which can give data relating to the surface that reflects that signal. When used in shearography, these interference patterns can tell you what is happening on the target surface 54 surface. Normal operation of shearography equipment typically has a single fixed shear which is set by the angle of mirror 24 relative to the components of the receiver optics 14. When it is desired to obtain a shearogram having a different shear, the hardware itself must be adjusted and a new data set must be collected. In other words, to change the shear, the mirror 24, or more specifically the angle of the mirror 24 must be physically and manually adjusted and the imaging process must be repeated to collect a new data set relating to the target surface 54. Current shearography methods typically generate shearograms utilizing a single fixed shear that is linear and is approximately constant across the image. Where different shear lengths are needed, the hardware must be adjusted for each desired shear length, and a new set of shear images and new data set must be collected. When performing shearography according to the example above, each location of vehicle 62 may require multiple shear lengths, resulting in multiple image sets and multiple data sets taken at every position of vehicle 62, with manual adjustments to the hardware between the collection of each image and data set.

In the case of remote detection of buried objects, the single fixed shear operation limits single-pass system performance, as discussed above, because buried objects tend to show a higher response level when detected at a shear length that is approximately one-half of the object's diameter. Utilizing systems having a fixed shear length in single-pass operations seeking objects of varying size, means many targets will not be interrogated at optimum shear and some targets may not be detected at all. Thus, the tradeoff for this application of shearography is the benefit of having a single pass system is often outweighed by the reduced accuracy in object detection. In certain applications, such as the detection of buried threats, including land mines, IEDs and the like, even a single missed object could have devastating consequences. Thus, the reduced accuracy is further magnified in these scenarios, and current single fixed shear length systems often require additional time to perform multiple shearography processes over each location to maintain accuracy. Even in current systems where the shear length can change across the focal plane, such as rotational shearing interferometers, the shear at any given pixel is fixed. Thus, to properly detect objects of varying size, the shear length would still require adjustment at each pixel and multiple image and data sets to maintain accuracy.

Accordingly, the processes described herein may utilize the system 10, as discussed above, to enable single-pass system performance while utilizing back-end image processing techniques to process the data collected in a single pass for the optimal shear length for each class of buried object within target surface 54. These processes may further enhance target surface 54 analysis by allowing the calculation of the object's response relative to the shear length and shear direction of system 10.

In traditional shearing, an interferometer using a single-fixed shear, the observed intensity at a given pixel may take the form:

I=I₁+I₂+2\sqrt{I₁I₂} cos(θ₁₂) (1.1)

Where I₁ and I₂ are the intensities from the un-sheared location r and sheared location r+Δr (where Δr is the shear) and θ₁₂ is the phase angle between the rays form r and r+Δr.

When computed for every pixel at time t₁ equation (“Eq.”) (1.1) represents the intensity of a specklegram image:

S(t₁)=I₁(i,j,t₁)+I₂(i,j,t₁)+2\sqrt{I₁(i,j,t₁)I₂(i,j,t₁)}cos(θ₁₂(i,j,t₁)) (1.2)

Shearograms are computed as a function of the difference between two specklegrams ΔS (a non phase resolved shearogram for example is simply |ΔS|²). Dropping pixel indices, and assuming I₁ and I₂ are constant over the time interval, provides:

$$\begin{matrix}Δ S = 2 \sqrt{{I}_{1} {I}_{2}} \{ cos ( {θ}_{12} ( {t}_{1} ) ) - cos ( {θ}_{12} ( {t}_{2} ) ) \} \\ = Δ {X}_{12}\end{matrix} \qquad ( 1.3 )$$

That is, only the term:

X₁₂=2\sqrt{I₁I₂} cos(θ₁₂) (1.4)

in Eq. (1.2) is important for shearogram generation.

Then, with the objective being to collect a set of interference images W that will allow the computation of X₁₂ for an arbitrary shear Δr (X₁₂(Δr)). For purposes of the present analysis, the shear Δr can be taken to be restricted to a shift in pixel locations from i,j to i′,j′ on W. That is:

Δr=Δr(Δi,Δj) (1.5)

Where Δi=i′−i and Δj=j′−j.
Thus, in this notation Eq. (1.4) becomes:

X₁₂=X(i,j,i′,j′)=2\sqrt{I(i,j)I(i′,j′)}cos(θ(i,j,i′j′)) (1.6)

Thus, a solution to the post processing shear computation problem is achieved by defining a set of images W from which Eq. (1.6) can be computed.
Below, it is shown that if the interferometric images W are obtained with a speckle holography system that supports global phase stepping of the reference wave, then, for a suitable choice of phase steps the desired quantity X(i,j,i′,j′) can be computed.
Let W₁ be a speckle holographic image with 0 phase step applied to the reference wave:

W₁(i,j)=I_{A}(i,j)+I_{R}(i,j)+2\sqrt{I_{A}(i,j)I_{R}(i,j)}cos(θ_{AR}(i,j)) (1.7)

Where I_{A} and I_{R} are the reflected and reference intensities and θ_{AR} is the phase angle between the reflected and reference waves.

Similarly let W₂ be a speckle holographic image with 90° phase step applied to the reference wave:

W₂(i,j)=I_{A}(i,j)+I_{R}(i,j)+2\sqrt{I_{A}(i,j)I_{R}(i,j)}cos(θ_{AR}(i,j)) (1.8)

It is relatively straightforward to estimate the intensities I_{A}(i,j) and I_{R}(i,j) from the intensity image W₁ (or W₂). The reference plane wave intensity I_{R} is constant across the image, W₁(i,j)˜I_{R} for any pixel where I_{A}(i,j)□0. Using the darkest pixel in W₁(i,j) an estimate for I_{R}

[symbol]

=arg min{W₁(i,j))} (1.9)

The reflected intensity I_{A}(i,j) is expected to vary slowing across the surface being imaged; conversely the cos(θ_{AR}(i,j)) term is expected to oscillate rapidly from pixel to pixel.
Applying a low pass filter to W₁, (for example a boxcar filter of kernel size k), yields:

[symbol]

W₁(i,j) [symbol] _{K}= [symbol] I_{A}(i,j)+I_{R} [symbol] _{K}+ [symbol] 2\sqrt{I_{A}(i,j)Iᵣ(i,j)}cos(θ_{AR}(i,j)) [symbol] □ [symbol] I_{A}(i,j) [symbol] _{K}+I_{R} (1.10)

Using Eq. (1.9) provides:

[symbol]

(i,j)= [symbol] W₁(i,j) [symbol] _{K}− [symbol] (1.11)

The interference terms in Eqs. (1.7) and (1.8) can now be written in terms of measurable quantities:

Y₁(i,j)=W₁(i,j)− [symbol] (i,j)− [symbol] □2\sqrt{I_{A}(i,j)I_{R}} cos(θ_{AR}(i,j)) (1.12)

Y₂(i,j)=W₂(i,j)− [symbol] (i,j)− [symbol] □2\sqrt{I_{A}(i,j)I_{R}} cos(θ_{AR}(i,j)) (1.13)

Where the notation Y₁ and Y₂ is introduced for convenience.
Currently all interference terms are given in terms of the reference wave θ_{AR}(i,j), the objective is to express interference in terms of θ(i,j,i′,j′). These are related by:

θ(i,j,i′,j′)=θ_{AR}(i,j)−θ_{AR}(i′,j′) (1.14)

Using Eq. (1.14) and simple trigonometric identities:

$$\frac{{Y}_{1} ( i , j ) {Y}_{1} ( {i}^{′} , {j}^{′} ) + {Y}_{2} ( i , j ) {Y}_{2} ( {i}^{′} , {j}^{′} )}{2 {I}_{R}} •2 \sqrt{I ( i , j ) I ( {i}^{′} , {j}^{′} )} cos ( θ ( i , j , {i}^{′} , {j}^{′} ) ) = X ( i , j , {i}^{′} , {j}^{′} ) \qquad ( 1.15 )$$

The objective of expressing Eq. (1.6) in terms of measurable quantities is achieved.

The generation of a Non Phase Resolved shearogram with shear Δi, Δj can be tested as follows using a speckle holography system, such as system 10:

### Data Collection:

Set test target to position 1
With reference wave at 0° phase step collect image W₁(t₁)
With reference wave at 90° phase step collect image W₂(t₂)

Set test target to position 2
With reference wave at 0° phase step collect image W₁(t₂)
With reference wave at 90° phase step collect image W₂(t₂)

### Computation:

Here i′=i+Δi and j′=j+Δj.

Using W₁(t₁) and W₂(t₁) compute X(i,j,i′,j′)

Using W₁(t₂) and W₂(t₂) compute X(i,j,i′,j′) from (1.15)

Compute the NPR Shearogram as:

NPR=|X(i,j,i′,j′,t₁)−X(i,j,i′,j′,t₂)|²

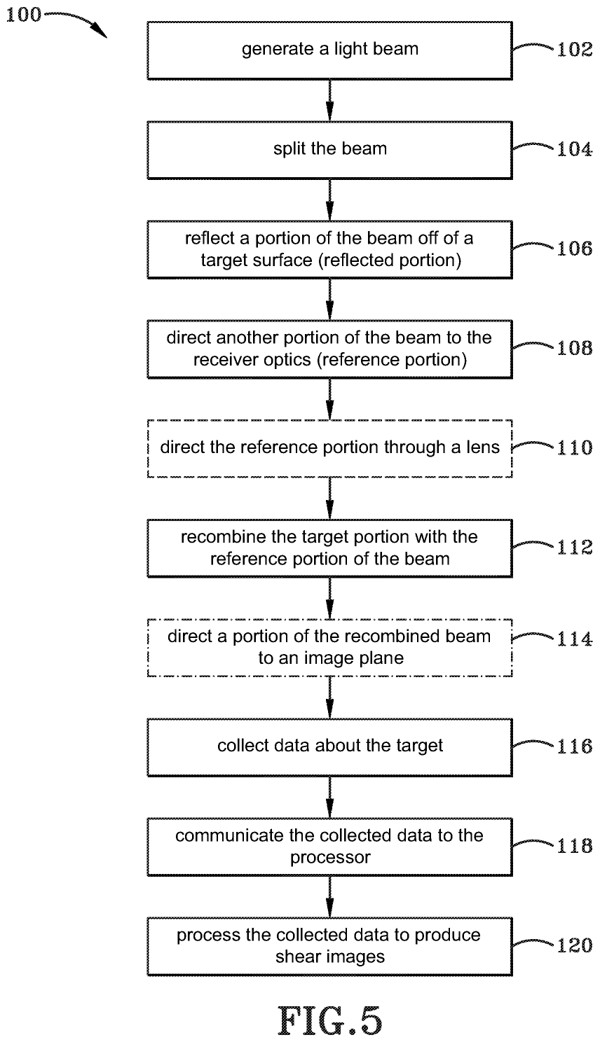

With reference to FIG. 5, an exemplary flow chart is shown and generally indicated as process 100. It will be understood that process 100 is an exemplary method of operation for system 10 previously described herein utilizing the advanced processing techniques discussed above.

Process 100 is an exemplary process of performing shearography to detect buried threats under a ground surface such as target surface 54. Although described for use for this particular purpose, it will be understood that process 100 may be utilized for any desired shearography applications as well as other similar imaging techniques and application.

The first step in process 100 is to generate a light beam 28 from the light input 16 and direct the light beam 28 into the first splitter 18. The generation of light beam 28 and direction thereof into first splitter 18 is generally indicated as step 102 in process 100. As beam 28 moves into first splitter 18 and encounters first splitting surface 20, it is split with approximately half of beam 28 being redirected to mirror 24 where it is reflected therefrom towards the receiver optics 14 as reference beam 32 and the remainder of the light passes through the first splitting surface 20 towards diverger lens 26. The splitting of beam 28 is indicated as step 104 in process 100.

Once light beam 28 is split, the portion encountering diverger lens 26 is diverged and projected outwards towards target surface 54 as the target illumination beam 30. This projection of target illumination beam 30 towards target surface 54 is indicated as step 106. As mentioned above, the other portion of beam 28 that is split and directed 90 degrees towards mirror 24 before being reflected therefrom and towards receiver optics 14 as reference beam 32 is indicated, the reflection and direction of reference beam 32 is indicated as step 108.

While target illumination beam 30 is travelling towards target surface 54, the reference beam may enter receiver optics 14 and may pass through lens 34 to collimate, resize, or otherwise organize reference beam 32 as it enters into the second splitter 36, which may function as a recombining optical component, as discussed above. The action of lens 34 on reference beam 32 is shown and indicated as step 110 in process 100. However, step 110 is illustrated as a dashed line box as step 110 is optional, depending on the specific configuration of system 10. For example, when using system 10 as illustrated in FIG. 1, step 110 is utilized as lens 34 is present within that system; however, when implemented using system 10 as shown in FIG. 2, where lens 34 is omitted, it will be understood that step 110 may likewise be omitted from process 100.

Simultaneously or in rapid succession with reference beam 32 entering the second splitter 36, the target illumination beam 30 may reflect off of the target surface 54 and may enter second splitter 36 as reflected beam 52. Second splitter 36, now functioning as a recombining optical component, may recombine or otherwise direct both reference beam 32 and reflected beam 52 into a first arm 48 towards the image plane 44 and a second arm 50 towards the beam dump 46. The recombination and direction of the reference beam 32 and reflected beam 52 is indicated as step 112 in process 100.

Next, indicated as step 114, the first arm 48 of the recombined reference beam 32 and reflected beam 52 may pass through the objective lens 42 before reaching the image plane 44. In this approach, the objective lens 42 may function to recollimate the reference beam onto the image plane 44. This step 114 is illustrated using a dash-dot line pattern box as step 114 may be performed in a different manner, depending on the particular implementation. For example, as discussed with reference to FIG. 1, step 114 may be performed with objective lens 42 in the first arm 48, between second splitter 36 and image plane 44. However, when implemented as illustrated in FIG. 2, the objective lens may be within the path of reflected beam 52 before reflected beam 52 enters second splitter and is recombined with reference beam 32. In this instance, step 114 would be performed to recollimate the reflected beam 52 prior to step 112, before the reflected beam 52 and reference beam 32 are recombined and directed to the image plane 44 and/or beam dump 46.

Once the reference beam 32 and reflected beam 52 are recombined and directed to the image plane 44 and/or beam dump 46, data may be collected via the image plane 44 relating to the interference patterns created by reflecting target illumination beam 30 off of target surface 54. The collection of data is indicated as step 116 in process 100. Once the appropriate data is collected, it may be communicated via output(s) 56 to processor 58 for further processing according to the methods and formulas provided herein. The data may be processed according to the methods and formulas herein to generate multiple shear images having different shear lengths for each image set all from the single data set collected in step 116. The communication of collected data to the processor is indicated as step 118 in process 100 while the processing of that data is indicated as step 120.

Process 100 may be repeated as system 10 is moved across an area to be tested, for example, by vehicle 62 as discussed previously herein. Each data set collected at each specific position may be collected using a fixed shear with no need or necessity of moving any physical components such as mirror 24 within system 10. Instead, the processing of the collected data in step 120 may be done according to the methods and formulas described herein, to allow for extrapolating the optimal shear length for each object class buried or contained within target surface 54 from each single data set at each position. Thus, the accuracy and detectability of objects in this particular implementation may be maintained at a high level while performing a single pass over the target surface 54.

Although described herein, as used for buried object detection, it will be understood that process 100 as well as the processing formulas and methods described herein may be readily adapted for other similar shearography or imaging applications as needed.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method of performing shearography comprising:
reflecting a target illumination beam off of a target surface via a transmitter optical component of a shearography system;
directing a reference beam from the transmitter optical component to a receiving optical component of the shearography system;
receiving a reflected beam from the target surface with the receiving optical component;
communicating a data set relating to the reflected beam relative to the reference beam from the receiving optical component to a processor; and
processing the data set to generate at least two shear image sets having different shear lengths for each image set.

2. The method of claim 1 further comprising:
detecting a first object beneath the target surface with a first optimal shear length in one of the at least two shear image sets; and
detecting a second object beneath the target surface with a second optimal shear length in another of the at least two shear images.

3. The method of claim 2 further comprising:
calculating the response of at least one of the first and second objects relative to the shear length and a shear direction of the shearography system

4. The method of claim 1 further comprising:
moving the transmitter optical component and the receiver optical component from a first location relative to the target surface to a second location relative to the target surface;
reflecting the target illumination beam off of the target surface in the second location;
directing the reference beam to the receiving optical component;
receiving the reflected beam from the target surface in the second location with the receiving optical component;
communicating a second data set relating to the reflected beam from the target surface at the second location relative to the reference beam from the receiving optical component to a processor; and
processing the second data set to generate at least two shear image sets for the target surface at the second location having different shear lengths for each image set.

5. The method of claim 4 further comprising:
generating the first data set from the first location and the second data set from the second location in a single pass over the target surface.

6. The method of claim 4 further comprising:
detecting a first object beneath the target surface with a first optimal shear length in one of the at least two shear image sets for the target surface at the second location; and
detecting a second object beneath the target surface with a second optimal shear length in another of the at least two shear image sets for the target surface at the second location.

7. The method of claim 6 further comprising:
calculating the response of at least one of the first and second objects relative to the shear length and a shear direction of the shearography system.

8. A system for detecting objects beneath a target surface, the system comprising:
a transmitter optical component operable to generate and reflect a target illumination beam off of the target surface;
a receiver optical component operable to receive a reflected beam from the target surface illuminated by the target illumination beam; and
a processor in operative communication with the receiver optical component operable to generate at least two shear image sets having different shear lengths for each of the at least two shear image sets from a single data set collected in a single pass of the system over the target surface.

9. The system of claim 8 wherein the processor is further operable to detect a first object beneath the target surface with a first optimal shear length in one of the at least two shear image sets and to detect a second object beneath the target surface with a second optimal shear length in another of the at least two shear image sets.

10. The system of claim 8 wherein the transmitter optical component further comprises:
a light source operable to generate a light beam;
a beam splitter operable to split the light beam into a first portion and a second portion, wherein the first portion is the target illumination beam and the second portion is directed 90° from the first portion as a reference beam; and
a mirror operable to reflect the reference beam into the receiver optical component.

11. The system of claim 10 wherein the system is movable from a first position relative to the target surface to a second position relative to the target surface.

12. The system of claim 11 wherein the system is operable to collect a first data set at the first location and a second data set at the second location in a single pass of the system over the target surface.

13. The system of claim 12 wherein the mirror is fixed and does not move between collecting the first data set at the first location and collecting the second data set at the second location.

14. The system of claim 13 wherein the processor is further operable to generate at least two shear image sets having different shear lengths for each of the at least two shear image sets from the first data set and to generate at least two additional shear image sets having different shear lengths for each of the at least two shear image sets from the second data set.

15. The system of claim 14 wherein the processor is further operable to detect a first object beneath the target surface with a first optimal shear length in one of the at least two shear image sets from the second data set and to detect a second object beneath the target surface with a second optimal shear length in another of the at least two shear image sets from the second data set.

16. A computer program product including one or more non-transitory machine-readable storage mediums encoding instructions that when executed by one or more processors cause a process to be carried out for generating multiple shear image sets with each image set of the multiple shear image sets having a different shear length, the process comprising:
receiving a reflected beam from a target surface that is illuminated by a target illumination beam;
collecting a single data set from the received beam relative to a reference beam; and
generating at least two shear image sets from the single data set with each image set from the at least two image sets having different shear lengths.

17. The computer program product of claim 16 wherein the process further comprises:
identifying a first object beneath the target surface with a first optimal shear length in one of the at least two shear image sets; and
identifying a second object beneath the target surface with a second optimal shear length in another of the at least two shear image sets.

18. The computer program product of claim 16 wherein the process further comprises:
moving the target illumination beam from a first position on the target surface to a second position on the target surface;
receiving a second reflected beam from the second position on the target surface that is illuminated by the target illumination beam;
collecting a second data set from the second reflected beam relative to the reference beam; and
generating at least two shear image sets from the second data set with each image set from the at least two image sets from the second data set having different shear lengths.

19. The computer program product of claim 18 wherein the process further comprises:
identifying a first object beneath the target surface with a first optimal shear length in one of the at least two shear image sets from the second data set; and
identifying a second object beneath the target surface with a second optimal shear length in another of the at least two shear image sets from the second data set.

20. The computer program product of claim 18 wherein the process further comprises:
collecting a first data set at the first position on the target surface and the second data set at the second position on the target surface in a single pass over the target surface.
